(19) United States
(12) Patent Application Publication
(10) Pub. No.: US 2008/0159504 A1
(43) Pub. Date: Jul. 3, 2008

(54) Method and apparatus for improved analog line migration to accommodate customer premise equipment changes

(76) Inventors: David L. Brugman, San Clemente, CA (US); Michael D. DeRousse, Red Bud, IL (US)

Correspondence Address: FAY SHARPE/LUCENT, 1100 SUPERIOR AVE, SEVENTH FLOOR, CLEVELAND, OH, 44114, US

(21) Appl. No.: 11/648,256

(22) Filed: Dec. 29, 2006

(51) Int. Cl. H04M 1/00

(52) U.S. Cl. 379/156

(57) ABSTRACT

A method and apparatus for improved analog line migration to accommodate customer premise equipment (CPE) changes are provided. For example, this development relates to a method and apparatus that controls per line migration of analog lines on the public switched telephone network (PSTN) where the telephone set change must be coordinated with, for example, Class 5 switch software changes.

### BACKGROUND

This invention relates to a method and apparatus for improved analog line migration to accommodate customer premise equipment (CPE) changes. For example, this development relates to a method and apparatus that controls per line migration of analog lines on the public switched telephone network (PSTN) where the telephone set change must be coordinated with, for example, Class 5 switch software changes.

While the invention is particularly directed to the art of line migration in a particular environment, and will be thus described with specific reference thereto, it will be appreciated that the invention may have usefulness in other fields and applications. For example, the invention may be used in a variety of situations where a change of customer premise equipment also requires a software change on a corresponding network.

By way of background, proper line migrations—necessitated by a customer premise equipment change—require coordination between the telephone instrument changes and per line software reprogramming of, for example, a Class 5 switch. The presently known methods for such line migration require a manual process of reprogramming each network element. This is a time-consuming process that results in excessive down-time of the network elements involved.

Moreover, manual data extraction for each line migration and the implementation of the required software changes at migration is both risky and time consuming. In case of failure, there is no mechanized back out procedure. So, the presently known methods do not provide a low risk, low cost line-by-line user-driven process for completing the migrations.

The present invention contemplates a new and improved technique that resolves the above-referenced difficulties and others.

### SUMMARY OF THE INVENTION

A method and apparatus for providing line migration from an analog line to new working arrangements is provided. In this regard, automation of required software changes for per line migration during a coordinated customer premise equipment change is realized. The migration, in one form, can be accomplished in a single transaction for the user. The presently described embodiments mechanize the entire process and perform all software changes based on an Internet web based request. Communications with the end user throughout the contemplated process are maintained through a web interface. These techniques also allow for the generation of statistical reports that allow administrators to monitor the overall conversion status of projects.

In one aspect of the presently described embodiments, the system comprises a user interface operative to receive instructions from a user on line configuration changes, a line migration broker in communication with the user interface, a switching element having information on a line configuration in communication with the line migration broker, wherein the line migration broker is operative to query the switching element on the line configuration information, receive the instructions from the user interface on the line configuration changes, implement the line configuration changes on the line configuration information based on the instructions to obtain modified line configuration data and send the modified line configuration data to the switching element, whereby lines may be migrated so that service provided by the first phone system type may be changed to service provided by the second phone system type.

In another aspect of the presently described embodiments, the user interface is a web interface.

In another aspect of the presently described embodiments, the web interface is a TCP/IP interface.

In another aspect of the presently described embodiments, the switching element is a Class 5 switch.

In another aspect of the presently described embodiments, the line migration broker is operative to query the switching element by requesting a dump of text on the line configuration.

In another aspect of the presently described embodiments, the migration broker is operative to implement changes by running a Perl script on the text to replace values.

In another aspect of the presently described embodiments, the line migration broker is operative to send a failure message if a request through the user interface is not valid.

In another aspect of the presently described embodiments, the line migration broker is operative to send a failure message if the changes are not successful.

In another aspect of the presently described embodiments, the information on the line configuration comprises information on line features and port assignments.

In another aspect of the presently described embodiments, the line migration broker is operative to rollback migration of lines.

In another aspect of the presently described embodiments, the method comprises receiving request to migrate lines through a web interface, validating the request, querying a switching element having control of the lines to obtain line configuration data, receiving the line configuration data, modifying the line configuration data based on the request, and, sending the modified line configuration to the switching element.

In another aspect of the presently described embodiments, the method further comprises sending a failure message if the validating is not successful.

In another aspect of the presently described embodiments, the method further comprises sending a failure message if the modifying is not successful.

In another aspect of the presently described embodiments, the method further comprises storing statistics based on the modifying.

In another aspect of the presently described embodiments, the method further comprises providing a software rollback of the lines.

In another aspect of the presently described embodiments, the querying comprises requesting a dump of text to obtain text on the line configuration data.

In another aspect of the presently described embodiments, the modifying comprises modifying values in the text.

In another aspect of the presently described embodiments, the sending comprises sending the modified text having replaced values to the switching element.

Further scope of the applicability of the present invention will become apparent from the detailed description provided below. It should be understood, however, that the detailed description and specific examples, while indicating preferred embodiments of the invention, are given by way of illustration only, since various changes and modifications within the spirit and scope of the invention will become apparent to those skilled in the art.

### DESCRIPTION OF THE DRAWINGS

The present invention exists in the construction, arrangement, and combination of the various parts of the device, and steps of the method, whereby the objects contemplated are attained as hereinafter more fully set forth, specifically pointed out in the claims, and illustrated in the accompanying drawings in which:

FIG. 1 is a block diagram of a system into which the presently described embodiments may be implemented.

FIG. 2 is a block diagram of a system into which the presently described embodiments are incorporated.

FIG. 3 is a flowchart illustrating a method according to the presently described embodiments.

### DETAILED DESCRIPTION

The present invention includes a method and apparatus for mechanized activation and deactivation of switch software, e.g. Class 5 line software, in all appropriate switching elements when customer premise equipment is changed—allowing for per line migrations in an efficient manner, e.g. in a single user visit to a web site. Change requests are initiated by connecting to a Line Migration Broker using a web browser. The activation or deactivation of software changes are performed on the switch when the user inputs a telephone number, through the browser, that may be included on a work list of expected changes for the Line migration Broker. If the telephone number is not oh the work list, the end user will be notified and no connection to the switch recent change-provisioning channel will be attempted.

The benefits of the method and apparatus in this invention include the following:

1. The end user can schedule the migration pace to coincide with the placement and programming of the replacement telephone.

2. This method reduces conversion risk and installation skill requirements.

3. The line can be converted in real time at any time of the day when the only requirement being the line must not be in use during the migration period.

4. The end user can request reverse software migrations if required.

5. The process delivers electronic progress reports to the administrators.

6. Security is enhanced because of the control and the limitations that can be placed on the migration request.

7. The migration can be efficiently accomplished, e.g. in one interaction with an appropriate web site.

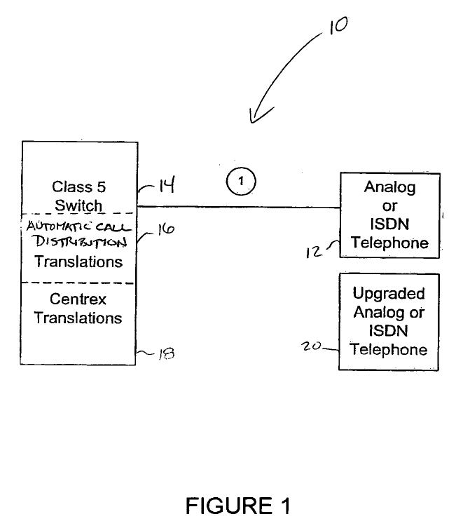

Referring now to the drawings wherein the showings are for purposes of illustrating the exemplary embodiments only and not for purposes of limiting the claimed subject matter, FIG. 1 provides a view of a system into which the presently described embodiments may be incorporated. As shown generally, FIG. 1 depicts a system 10 as it may be configured prior to an analog migration and telephone equipment change.

In this regard, Link 1 represents a connection, e.g. a dial tone connection, from a phone 12 to a switch 14, e.g. a Class 5 switch, before migration begins. Dial tone to a line to be migrated is delivered over link 1. Link 1 represents both the facility-to-telephone wiring and the Class 5 switch port that supplies the dial tone. This connection (facility to switch port) will be reused after the migration. Also shown are Automatic Call Distribution (ACD) software components 16, associated with the line before migration, and local network software components 18, e.g. Centrex software translations, that will be associated with the line after migration. These components 18 are available on the Class 5 switch but, as shown, are not activated.

It should be appreciated that the phone 12 may take on a variety of forms of different types of systems, including that of an analog or ISDN telephone. A phone 20 is also shown and represents the upgraded telephone set that will be used after migration including an analog or ISDN phone. This piece of equipment may take a variety of suitable forms or types as well. Likewise, the switch 14 and associated software components 16 and 18 are of known forms.

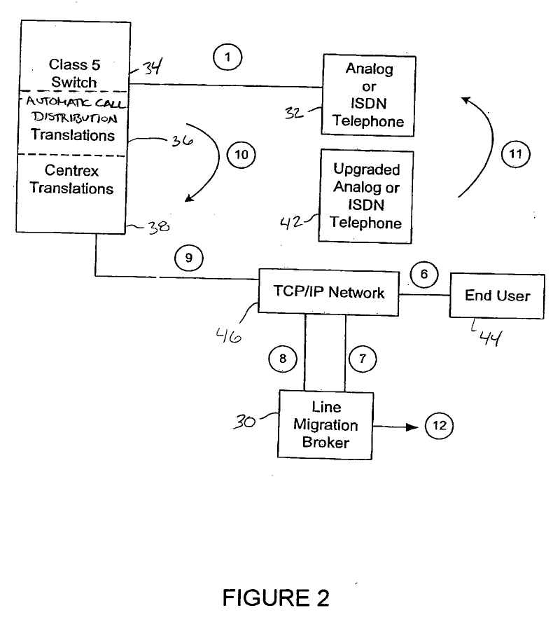

With reference now to FIG. 2, a configuration that represents a system subsequent to a migration process is illustrated. Notably, in FIG. 2, placement of a Line Migration Broker 30 during a line migration period is depicted.

It should be appreciated that the Line Migration Broker 30 only needs to be active in the network during the customer defined transition period. It need not be a permanent network element. However, it should also be appreciated that the Broker 30 may take a variety of forms. It may be implemented using various software techniques and/or different hardware configurations. For example, the Broker 30 may be implemented as a software routine that primarily resides on the switching element or distributed on the network.

In one form, a serving computer is used as a Line Migration Broker 30 and is placed on an internal network segment of a service provider that has access to the associated network element provisioning channels. The Line Migration Broker 30 is accessed through standard web browser connectivity. The user uses simple browser input requests for desired changes. All changes are first verified for validity and delivered to the proper network elements in the correct order. When the end user selects a telephone number and then requests a migration, the Line Migration Broker issues and monitors the network element software changes and provides real-time status updates.

The software tools on the Line Migration Broker may take a variety of forms, but in one form, include a Web server, an SQL database, programming languages to communicate with network elements using text interfaces, the TCP/IP communications utilities and custom Shell, Perl, AWK, PHP, SQL and Tool Control Language Expect scripts.

The Web server provides the user interface for the change provisioning requests and report outputs. Change provisioning was done previously through direct access to the Class 5 switch and per line change inputs. This activity is now done through a simple Web browser.

Use of, and extremely restricted access to, the SQL database provides the connection security typical users require. It also maintains in a secure fashion all of the software messaging that will be delivered to the Class 5 switches. It is also used to track all access and store delivery benchmarks. The database is also used to generate activity reports when the user requests them.

The software scripts mechanize access security, software change message generation, Class 5 communications for data collection and software change message delivery, SQL database administration and user report generation. Previously, this work was typically done using several provisioning support systems.

The capability the invention provides reduces the line migration period from several hours about a minute. It also obviates the need for as many as 5 of the previously required 6 support system work orders.

Referring back now to FIG. 2, as shown, Link 1 represents the dial tone connection from a phone 32 to a switch 34, e.g. a Class 5 switch, before migration begins. This connection (facility to switch port) will be reused. Automatic Call Distribution (ACD) software components 36 are shown. These components are disassociated from the line at migration. Centrex software components 38 are also shown. These components 38 are associated with the line after migration. The phone 32, e.g. an analog or ISDN telephone, is shown and is removed at line migration. The upgraded telephone set 42 replaces the phone device 32 after the migration.

Link 6 represents a connection between an end user 44 and a provisioning TCP/IP network 46. Link 7 represents the web interface connection between the Line Migration Broker 30 and the provisioning TCP/IP network 46. Link 8 represents the Line Migration Broker 30 text interface between the provisioning network 46 and the mechanized Broker processes. Link 9 represents the recent change interface between the provisioning network 46 and the switch 34. Link 10 represents the software changes on the switch 34 that are delivered by the Line Migration Broker 30 when requested by the end user 44.

Link 11 represents replacement of the telephone set in coordination with the software changes in link 10. It should be appreciated that the facility and switch port in link 1 will be reused. Link 12 represents connection to support system database update mechanisms. This link be informational or a TCP/IP port that can deliver the information through electronic processes such as email or File Transfer Protocol.

The software changes contemplated herein may take a variety of forms as a factor of the operating system, programming language, and the like. However, in at least one form, the software changes include a change of messaging for new line configurations that are unique to the serving Class 5 switch type, new line functionality requirements and replacement telephone instrument differences. The change messages are constructed based on current line software equipage, the user's predefined replacement line feature needs and replacement telephone instrument facility requirements. Software messaging to restore the original line functionality is also prepared so that the user can reverse the migration in order to restore service in case difficulties are encountered, for example, a non-working replacement telephone instrument.

In operation, a person administering the Line Migration Broker 30 typically establishes a work order list that is placed on the Line Migration Broker 30 before any migrations are initiated. This may be accomplished using a variety of software techniques.

The actual migration begins by establishing web browser access to the Line Migration Broker 30 by the end user 44 across link 6. The user, from the browser on their personal computer, accesses the Line Migration Broker Web server. In one form, no special software on the personal computer is required. The Line Migration Broker's Web server then requests a valid user logon and password from the user. The user inputs these requirements. The Line Migration Broker's database is consulted using the Personal Home Page (PHP) script that administers the Web server. If access is granted, the user then selects the Class 5 switch that is serving the line that will be migrated through the Web interface using a drop down box that reflects valid switches from the Line Migration Broker database. The database on the Line Migration Broker is again interrogated this time using a programming language such as a Perl script for exact Class 5 connection requirements and the users permission to access it. If the user is validated, the Line Migration Broker uses the internal database connection information to access the Class 5 switch through the intervening support systems, or it can connect to the switch directly it if there are no associated support systems. Once connection to the Class 5 switch has been established the user is notified and the connection is logged in the Line Migration Broker database using a shell driven Perl script.

The end user 44 inputs a telephone number to be migrated using the web portal and requests migration by clicking on an appropriate Web page event (link 7). The telephone number is associated with a work order for security purposes.

If the telephone number input by the end user matches an item on the work list, the Class 5 provisioning channel is accessed through links 8 and 9. The telephone number on the work list is interrogated and the current features are stored. The Line Migration Broker checks the migration state on the line and if the state is pre-migration, the broker verifies the line software, computes the migration forward and rollback messaging, and sends the changes to the Class 5 using a native protocol. It should be appreciated that the computing of messaging regarding the changes involves a number of functions including generating provisioning orders. For example, the switch is queried by the Line Migration Broker to obtain a text dump of information on the features that are available on the line and the port assignments. A Perl script (prepared by the user using appropriate mapping information) is run on the text to replace features in the text, based on the mapping information. By modifying the text, the switch will be able to understand the changes when it receives them. So, once the changes are received by the switch, the line is evolved to it migrated state.

Provisioning orders for line configuration changes are also prepared in real time using the feature mapping tools on the Line Migration Broker 30. In this regard, the line configuration changes are constructed based on current software equipage, switch port assignment, replacement telephone instrument type and the replacement feature functionality. The current line equipage is collected and analyzed as an integral part of the process. Scripts for this data collection are stored by Class 5 switch type and are associated with the switch under migration in the internal Line Migration Broker database. Also, the feature mapping tools typically take the form of custom scripts based on the user's needs that are placed on the Line Migration Broker. The mapping requirements are documented in a text file and Perl and AWK scripts are constructed to build and store the software change messages required for migration and rollback. Appropriate software changes are then delivered to the switch 34 and monitored by the Line Migration Broker 30 over links 8 and 9 (as described above). These software changes include Class 5 specific software messaging and the appropriate protocols to administer message specific provisioning channel conversations on a per change basis. As the changes are sent to the switch all expected switch provisioning channel responses are accounted for and answered without user intervention. Link 10 represents the roll forward of the switch software. In this context, a roll forward includes line software feature removals and additions based on the previously described mapping requirements. The switch port providing dial tone is not changed.

Once the Class 5 notifies the Broker that the requested software changes have been completed, the activity is logged in the Broker database and the user is notified. This process continues until all lines scheduled for the session have been migrated. When the user is ready to log off, he/she requests a Line Migration Broker to Class 5 provisioning channel disconnect. After the disconnect is complete, the user is notified and is free to either generate reports or disconnect from the web page. If the user disconnects from the browser without disconnecting the Broker to Class 5 provisioning channel connection, the Broker will automatically disconnect the channel in the users defined default period.

A rollback provisioning order for the switch 34 is also prepared and stored for future use in real time. Typically, a rollback provisioning order includes all software features that are associated with a specific line before any migration is requested. The rollback provisioning order is constructed in a way that allows changes to be applied to the line in the migrated state. A rollback order cannot be applied to a line unless it has been previously migrated. Current migration status is stored in the work list.

Briefly, as detailed above, a typical migration session includes many steps. At times, the user will already be logged into the Line Migration Broker and a work error has occurred in the field or the replacement telephone instrument is not functioning correctly. The user then types the telephone number to be rolled back into the migration request text box in the browser and requests a rollback. The work-list on the Line Migration Broker is checked and if the line requested has a status of migration complete in the internal database, it sends the changes (as above) to the Class 5 using it's native protocol. Once the Class 5 notifies the Broker that the requested software changes have been completed, the activity is logged in the Broker database and the user is notified. The user notifies the person changing the instrument that the rollback has been completed.

If the migration operation is successful, a success message is sent to the end user 44 via the browser on the web portal over links 6 and 7. Concurrent with the switch software changes, the telephone 40 needs to be changed (e.g. via link 11 as shown). At this point, the end user 44 verifies operation of the new telephone 42. If the new telephone 42 does not function properly, a reverse migration can be requested by placing another request to the Line Migration Broker 30 (link 6 and 7). The software upgrade represented by link 10 will be reversed and a roll back successful message will be sent to the end user. This reversal includes the steps of checking the work list to make sure the line is the migrated state, applying the pre-constructed software messaged to move the line software to the pre-migration state, updating the work list to indicate the line has been rolled back to it's original state and user notification indicating that the rollback software changes have been completed. At session completion, statistics will be updated on the Line Migration Broker 30 and displayed to the end user 44. Statistics will also be logged for each step in this process. The end user can then migrate the next line.

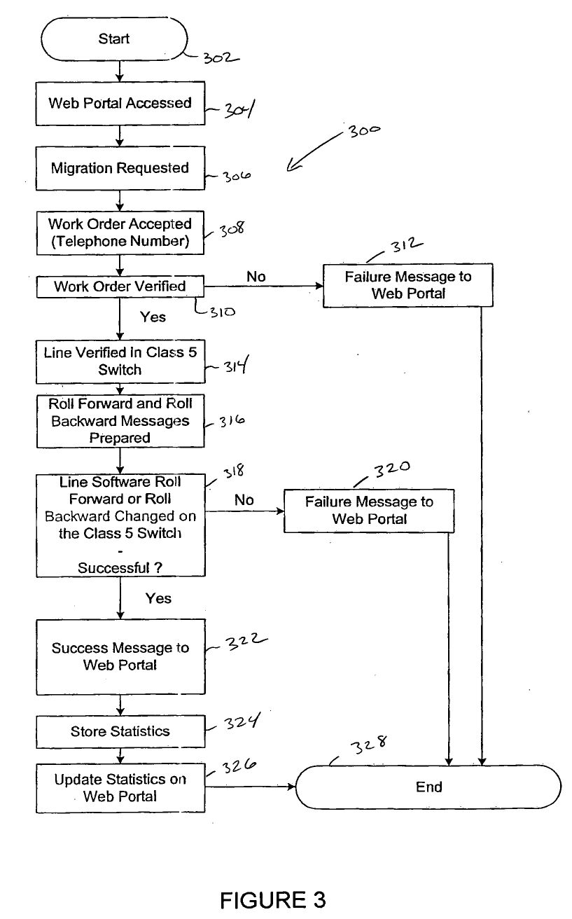

To serve as a further example of implementation and for clarity, FIG. 3 is a flowchart illustrating a method 300 according to the presently described embodiments. It should be appreciated that the methods according to the presently described embodiments may be implemented using a variety of suitable software techniques and hardware configurations. For example, as noted above, suitable software routines may be maintained on any of the network elements such as the Line Migration Broker 30 or the switch 34. Of course, the software may be distributed among various network elements.

With reference now to FIG. 3, the process is initiated (at 302) when the Line Migration Broker 30 is accessed from a web portal using a web browser on the provisioning TCP/IP network 46 (at 304). The end user 44 requests activation of the appropriate (e.g. Class 5) software changes by entering the telephone number of the line to be transformed (at 306). From this point forward, the Broker mechanizes all processes. Once the work order (telephone number) is received (at 308), the number is verified (at 310) using a previously inserted list of expected requests on the Line Migration Broker 30. If the work order is invalid, the user is notified via a failure message to the web portal (at 312). If the work order is valid, the switch 34 (e.g. a Class 5 switch) is interrogated for the current status of the line to be migrated (at 314). Roll forward and roll back provisioning messages are prepared in real time (at 316). The information from the interrogation is combined with feature mapping information (e.g. Centrex information) housed on the Line Migration Broker 30 and the line is sent to the switch 34 recent change provisioning channel under control of the Broker (at 318). If the change fails, the end user is notified via a failure message that is delivered to the web portal (at 320). If the change is successful, the end user is notified via the web portal (at 322) and statistics are stored (at 324). Current overall project statistics are then sent to the web portal as a screen update (at 326). The Line Migration Broker is then ready for the next migration request (at 328).

The above description merely provides a disclosure of particular embodiments of the invention and is not intended for the purposes of limiting the same thereto. As such, the invention is not limited to only the above-described embodiments. Rather, it is recognized that one skilled in the art could conceive alternative embodiments that fall within the scope of the invention.

We claim:

1. A system for migrating lines in a network from a first phone system type to a second phone system type, the system comprising:
a user interface operative to receive instructions from a user on line configuration changes;
a line migration broker in communication with the user interface;
a switching element having information on line configuration in communication with the line migration broker;
wherein the line migration broker is operative to query the switching element on the line configuration information, receive the instructions from the user interface on the line configuration changes, implement the line configuration changes on the line configuration information based on the instructions to obtain a modified line configuration and send the modified line configuration to the switching element,
whereby lines may be migrated so that service provided by the first phone system type may be changed to service provided by the second phone system type.

2. The system as set forth in claim 1 wherein the user interface is a web interface.

3. The system as set forth in claim 2 wherein the web interface is a TCP/IP interface.

4. The system as set forth in claim 1 wherein the switching element is a class 5 switch.

5. The system as set forth in claim 1 wherein the line migration broker is operative to query the switching element by requesting a dump of text on the line configuration.

6. The system as set forth in claim 5 wherein the migration broker is operative to implement changes by running a Perl script on the text to replace values.

7. The system as set forth in claim 1 wherein the line migration broker is operative to send a failure message if a request through the user interface is not valid.

8. The system as set forth in claim 1 wherein the line migration broker is operative to send a failure message if the changes are not successful.

9. The system as set forth in claim 1 wherein the information on line configuration comprises information on line features and port assignments.

10. The system as set forth in claim 1 wherein the line migration broker is operative to rollback migration of lines.

11. A method for migrating lines in a telephone network from a first phone system type to a second phone system type, the method comprising:
receiving request to migrate lines through a web interface;
validating the request;
querying a switching element having control of the lines to obtain line configuration data;
receiving the line configuration data;
modifying the line configuration data based on the request; and,
sending a modified line configuration to the switching element.

12. The method as set forth in claim 11 further comprising sending a failure message if the validating is not successful.

13. The method as set forth in claim 11 further comprising sending a failure message if the modifying is not successful

14. The method as set forth in claim 11 further comprising storing statistics based on the modifying.

15. The method as set forth in claim 11 further comprising providing a software rollback of the lines.

16. The method as set forth in claim 11 wherein the querying comprises requesting a dump of text to obtain text on the line configuration data.

17. The method as set forth in claim 16 wherein the modifying comprises modifying values in the text.

18. The method as set forth in claim 17 wherein the sending comprises sending the modified text having replaced values to the switching element.
